(19) United States
(12) Patent Application Publication
(10) Pub. No.: US 2024/0257251 A1
(43) Pub. Date: Aug. 1, 2024

(54) PROVIDING RELEVANT ENTITIES FOR THEMATIC INVESTING USING NATURAL LANGUAGE PROCESSING AND NAMED-ENTITY RECOGNITION

(71) Applicant: MICROSOFT TECHNOLOGY LICENSING, LLC, Redmond, WA (US)

(72) Inventors: Ehsan BEHNAMGHADER, Seattle, WA (US); Jitu K. KESHRI, Bellevue, WA (US); Qingwei GUO, Redmond, WA (US); Gangadharan VENKATASUBRAMANIAN, Seattle, WA (US)

(21) Appl. No.: 18/102,005

(22) Filed: Jan. 26, 2023

(51) Int. Cl. G06Q 40/06; G06F 16/9535; G06F 16/9538; G06F 40/295; G06F 40/30

(52) U.S. Cl. CPC G06Q 40/06

(57) ABSTRACT

Disclosed herein is a system for automatically providing a list of investments (e.g., securities such as individual stocks, Exchange-Traded Funds (ETFs)) to users (e.g., retail investors) using a machine learning model and a named-entity recognition algorithm. The machine learning model is generated and trained to implement natural language processing. Consequently, the system provides an opportunity for a non-sophisticated investor (e.g., a retail investor) to efficiently discover investments related to an investment theme. The system leverages a pipeline to generate a list of investments (e.g., ticker symbols for stocks or ETFs) that are the most relevant to and/or most impacted by the investment theme. The system can then display the list of investments to users.

### BACKGROUND

Thematic investing is a form of investment that identifies trends and, more importantly, a list of investments (e.g., securities such as individual stocks, Exchange-Traded Funds (ETFs)) that are likely to benefit from the trends. Recently, thematic investing has gained significant traction with “retail” investors due to its profitability and forward-looking nature with respect to market movement. A retail investor is a non-professional investor who is able to buy and sells securities on their own via a trading platform without contracting with an “expert” such as a financial advisor that charges advisor fees. Not having to pay advisor fees has contributed, and still contributes, to the growth and/or profitability of thematic investing. For example, in the United States of America, hundreds of thematic investing ETFs, with roughly $125B Asset Under Management (AUM), can be bought and sold by retail investors.

Unfortunately, compiling a list of investments related to a new, trending theme requires an extraordinary amount of manual work from investment experts. Consequently, the scalability of thematic investing for retail investors is severely hampered because the investments experts do not allocate the time to compile lists of investments related to new, trending themes. Additionally, the amount of manual work required often causes a significant time delay related to providing the list of investments to retail investors. Investment success often depends upon real-time information and quick action. Accordingly, the significant time delay related to providing the list of investments to retail investors can, at times, have a negative effect on thematic investing. It is with respect to these and other considerations that the disclosure made herein is presented.

### SUMMARY

The techniques disclosed herein implement a system that automatically provides a list of investments (e.g., securities such as individual stocks, Exchange-Traded Funds (ETFs)) to users (e.g., retail investors) using a machine learning model and a named-entity recognition algorithm. The machine learning model is generated and trained to implement natural language processing. Consequently, the system provides an opportunity for a non-sophisticated investor to efficiently discover investments related to an investment theme. The system leverages a pipeline, as described below, to generate a list of investments (e.g., ticker symbols for stocks or ETFs) that are the most relevant to and/or most impacted by the investment theme. The system can then display the list of investments to the users.

One of the advantages provided to investors by the pipeline relates to the efficiency with which investments for an investment theme can be discovered. As described above, previously investments experts would have to manually compile a list of investments related to a new, trending theme and this makes it difficult, if not possible, for a retail investor to receive up-to-date information (e.g., fresh data and not stale data) regarding investments related to an investment theme. In contrast, the system and pipeline described herein can efficiently provide investments related to a “hot” investment theme (e.g., based on recent/trending news) thereby increasing the chance of success for a retail investor.

An investment theme can include any investment topic, whether broad, narrow, or somewhere in between. Thus, an investment theme typically includes text (e.g., words and/or phrases) that focus on an industry (e.g., “automobiles”), a segment of an industry (e.g., “electrical vehicles”), a subsegment of a segment of an industry (e.g., “electrical vehicle batteries”), an event (e.g., “rising federal interest rates” or the “Inflation Reduction Act”), or a combination thereof. For example, “electrical vehicles” may be considered a narrower investment theme when compared to electrical vehicles. In another example, “electrical vehicle sales considering rising federal interest rates and/or the Inflation Reduction Act” may be considered a narrow investment theme. Previously, if a retail investor is intrigued by electrical vehicles from the investment perspective, the retail investor would have to read a large number (e.g., hundreds) of online articles related to electrical vehicles, which are authored by investment experts, to increase the chance of success regarding investing in electrical vehicles. Alternatively and/or additionally, the retail investor could contract with a financial advisor to receive expert input to increase the chance of success regarding investing in electrical vehicles. However, most retail investors do not have the time to read a large number of online articles, particularly when they are released in a short period of time (e.g., hundreds of different online articles were recently written about a new/trending theme). Moreover, many retail investors want to avoid the fees charged by financial advisors.

The system described herein solves these issues by automatically providing a list of investments using a machine learning model generated and trained to implement natural language processing. The machine learning model ranks network resources based on relevance scores. Furthermore, the system uses a named-entity recognition algorithm to recognize entities mentioned in the network resource.

The system receives a query that identifies an investment theme that is related to a market that includes tradeable securities. In one example, a user, such as a retail investor or another consumer of investment recommendations, specifies the investment theme and submits the query to the system. In another example, the system identifies the investment theme and generates its own query without user input by selecting topics from trending news that have shown, and are likely to continue to have, high user engagement. Consequently, implementation of a pipeline described herein can be user-driven or system-driven.

The system leverages a search engine to identify network resources (e.g., Uniform Resource Locators (URLs)) via which financial and/or investment content related to the investment theme is made available. For example, the text of the investment theme in the query is passed to the search engine so the search engine can perform a search. The search returns the network resources via a search engine results page (SERP). A number of network resources returned by the search can be capped at a search results threshold number N (e.g., N=100, N=1,000, N=10,000) to help ensure more efficient processing later in the pipeline.

A network resource includes network-based content that is publicly available via various websites. For example, a network resource can include an article written by investment and/or financial experts. The network resources may be returned in a ranked order based on recency (e.g., a publish date of the article) and/or popularity (e.g., a number of times the article has been clicked on or viewed by users). This can help ensure that the more relevant network resources (e.g., relevant from the perspective of time and/or quality) are considered by the pipeline first. Consequently, the search engine is the first component used in the aforementioned pipeline.

While the search engine can find the more recent and/or more popular network resources related to an investment theme, the search engine is not configured to closely examine the content of the network resources to confidently determine the relevance of a network resource to the investment theme. Therefore, after the search engine returns the network resources, the system applies a second component in the pipeline to each network resource. The second component is a machine learning model that has been generated and trained to implement natural language processing. For example, the machine learning model is generated and trained using deep-learning architectures such as deep neural networks, deep belief networks, deep reinforcement learning, recurrent neural networks, convolutional neural networks, and/or Transformers. In one example, the machine learning model is generated and trained to implement natural language processing based on Sentence Bidirectional Encoder Representations from Transformers (SBERT).

The machine learning model receives the content of a network resource returned by the search engine as an input and semantically determines a relevance of the content to the investment theme. Accordingly, the machine learning model is generated and trained to semantically understand the investment theme and output a score for the network resource. The score represents a degree to which the content discussed in the network resource is relevant to the investment theme. The system can then rank the network resources received from the search engine based on the relevance scores that are output by the machine learning model. This ranking produces a ranked list of network resources.

Semantic understanding includes identifying related words and phrases discussing the investment theme. As an example, if the investment theme includes “electrical vehicles”, the discussion of “EV batteries” and/or “EV charging stations” is related to the investment theme and the machine learning model is trained to semantically understand these relationships. Furthermore, semantic understanding includes determining whether the relevant discussion in a network resource is bullish (e.g., the values of related stocks and ETFs are predicted to increase) or bearish (e.g., the values of related stocks and ETFs are predicted to decrease). Generally, bullish discussions of the investment theme contribute to higher relevance scores and bearish discussions of the investment theme contribute to lower relevance scores.

The machine learning model described herein can continually be trained (e.g., updated) to account for, and to understand new, trending investment themes. Therefore, the machine learning model is able to provide information based more on facts related to trending news and based less on interpretations or reactions to the trending news. In contrast, the manual approach to compiling a list of investments for investment themes (and any tools used by investment experts) is only able to consider network resources that published prior to a certain point of time. This point in time is typically a considerable amount of time prior to when the final list of investments is made available to investors. Consequently, this approach leads to a final list of investments that may be stale or that is lacking factuality.

Once the system determines a ranked list of the network resources returned from the search engine, the system identifies a relevance threshold number N (e.g., N=25, N=50, N=100, N=1000) of the top-ranked network resources from the ranked list of network resources. The system then applies a third component in the pipeline to each top-ranked network resource. The third component is a named-entity recognition (NER) algorithm configured to recognize entity representations (e.g., company names, ticker symbols) for securities that can be traded (e.g., i.e., bought and sold). Consequently, the system applies the named-entity recognition algorithm to each of the top-ranked network resources to recognize and extract entities associated with a tradeable security. The system can then provide at least a portion of recognized entities for display in association with the investment theme.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates an example environment in which a system is configured to automatically provide a list of investments to users based on an investment theme.

FIG. 2 illustrates an example graphical user interface in which the list of investments associated with an investment theme can be displayed to a user via a computing device.

FIG. 3 illustrates an example diagram that captures how parameters associated with named entities (e.g., ticker symbols) can be used to produce a ranked list of investments.

FIG. 4 illustrates an example diagram that captures how the content of a network resource can be segmented to focus the named-entity recognition and to protect against false positives.

FIG. 5 is a flow diagram of an example method for automatically providing a list of investments to users based on an investment theme.

FIG. 6 is a computer architecture diagram illustrating an illustrative computer hardware and software architecture for a computing system capable of implementing aspects of the techniques and technologies presented herein.

### DETAILED DESCRIPTION

The following Detailed Description discloses techniques and technologies for automatically providing a list of investments (e.g., securities such as individual stocks, Exchange-Traded Funds (ETFs)) to users (e.g., retail investors) using a machine learning model and a named-entity recognition algorithm. As described below, the machine learning model is generated and trained to implement natural language processing. Consequently, the system provides an opportunity for a non-sophisticated investor to efficiently discover investments related to an investment theme. The system leverages a pipeline, as described in the figures below, to generate a list of investments (e.g., ticker symbols for stocks or ETFs) that are the most relevant to and/or most impacted by the investment theme. The system can then display the list of investments to the users.

As described above, an investment theme can include any investment topic, whether broad, narrow, or somewhere in between. Thus, an investment theme typically includes text (e.g., words and/or phrases) that focus on an industry (e.g., “automobiles”), a segment of an industry (e.g., “electrical vehicles”), a subsegment of a segment of an industry (e.g., “electrical vehicle batteries”), an event (e.g., “rising federal interest rates” or the “Inflation Reduction Act”), or a combination thereof. For example, “electrical vehicles” may be considered a broad investment theme. In another example, “electrical vehicle sales considering rising federal interest rates and/or the Inflation Reduction Act” may be considered a narrower investment theme when compared to electrical vehicles. Previously, if a retail investor is intrigued by electrical vehicles from the investment perspective, the retail investor would have to read a large number (e.g., hundreds) of online articles related to electrical vehicles, which are authored by investment experts, to increase the chance of success regarding investing in electrical vehicles. Alternatively and/or additionally, the retail investor could contract with a financial advisor to receive expert input to increase the chance of success regarding investing in electrical vehicles. However, most retail investors do not have the time to read a large number of online articles. Moreover, many retail investors want to avoid the fees charged by financial advisors.

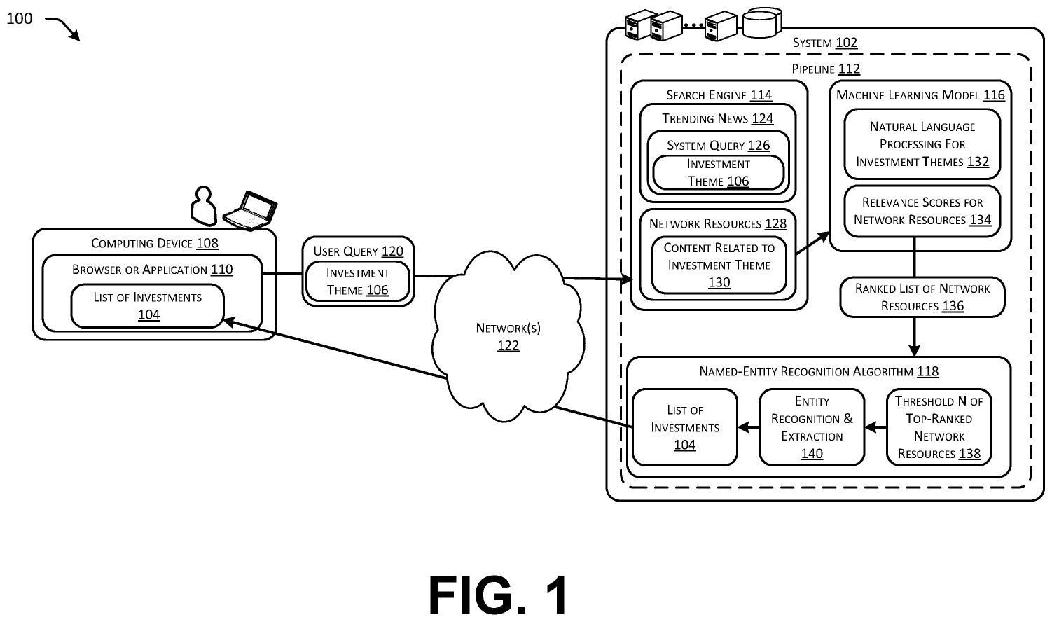

The system described below solves these issues by automatically providing a list of investments using a machine learning model generated and trained to implement natural language processing, as well as a named-entity recognition algorithm. Various examples, scenarios, and aspects are described below with reference to FIGS. 1-6.

FIG. 1 is a diagram illustrating an example environment 100 in which a system 102 is configured to automatically provide a list of investments 104 to a user based on an investment theme 106 related to a market. In various examples, device(s) of the system 102 can include one or more computing devices that operate in a cluster or other grouped configuration to share resources, balance load, increase performance, provide fail-over support or redundancy, or for other purposes. For instance, device(s) of the system 102 can be server-type devices.

As shown in FIG. 1, a computing device 108 of the user can display the list of investments 104 via a browser or application 110. The system 102 is configured to execute a pipeline 112 of components to perform the techniques described herein. The pipeline 112 includes a search engine 114, a machine learning model 116, and a named-entity recognition algorithm 118, each of which is discussed in detail below.

The system 102 receives and/or processes a query that identifies an investment theme 106 that is related to a market that includes tradeable securities. In one example, a user, such as a retail investor or another consumer of investment recommendations, specifies the investment theme 106 by providing input to the browser or application 110. Accordingly, the query is a user query 120 and the browser or application 110 submits the user query 120 to the system 102 via the computing device 108 over networks 122.

The computing device 108 can include, but is not limited to, a desktop computing device, a tablet computing device, a laptop computing device, a smartphone computing device, a wearable computing device, or any other sort of computing device. To this end, the computing device 108 can include input/output (I/O) interfaces that enable communications with input/output devices such as user input devices including peripheral input devices (e.g., a keyboard, a mouse, a pen, a voice input device, a touch input device, a gestural input device, and the like) and/or output devices including peripheral output devices (e.g., a display, a printer, audio speakers, a haptic output device, and the like). The computing device 108 can also include network interface(s) to enable communications between device(s) over network(s) 122. Such network interface(s) can include a network interface controller (NIC) or other types of transceiver devices to send and receive communications and/or data over network(s) 122.

Network(s) 122 can include, for example, public networks such as the Internet, private networks such as an institutional and/or personal intranet, or some combination of private and public networks. Network(s) 122 can also include any type of wired and/or wireless network, including but not limited to local area networks (LANs), wide area networks (WANs), satellite networks, cable networks, Wi-Fi networks, WiMax networks, mobile communications networks (e.g., 3G, 4G, 5G, and so forth) or any combination thereof. Network(s) 122 can utilize communications protocols, including packet-based and/or datagram-based protocols such as internet protocol (IP), transmission control protocol (TCP), user datagram protocol (UDP), or other types of protocols. Moreover, network(s) 122 can also include a number of devices that facilitate network communications and/or form a hardware basis for the networks, such as switches, routers, gateways, access points, firewalls, base stations, repeaters, backbone devices, and the like.

Additionally and/or alternatively, the system 102 can identify the investment theme 106 and generate its own query without user input. For instance, the search engine 114 can analyze trending news 124 and select an investment theme 106 that has shown, and is likely to continue to show, high user engagement based on the trending news 124. Accordingly, FIG. 1 illustrates a system query 126 generated internally based on trending news topics. Consequently, implementation of the pipeline 112 described herein can be user-driven or system-driven.

Once a query 120, 126 is received, the system 102 leverages the search engine 114 to identify network resources 128 (e.g., Uniform Resource Locators (URLs)) via which financial and/or investment content related to the investment theme 130 is made available. For example, the text of the investment theme 106 in the query 120, 126 (e.g., “electrical vehicles” or “electrical vehicle sales considering rising federal interest rates and/or the Inflation Reduction Act”) is passed to the search engine 114 so the search engine 114 can perform a search. Based on the search, the search engine 114 returns the network resources 128 via a search engine results page (SERP). A number of network resources 128 returned by the search can be capped at a search results threshold number N (e.g., N=100, N=1,000, N=10,000) to help ensure more efficient processing later in the pipeline 112.

A network resource 128 includes network-based content that is publicly available via various websites. For example, a network resource 128 can include an article written by investment and/or financial experts. The network resources 128 may be returned by the search engine 114 in a ranked order based on recency (e.g., a publish date of the article) and/or popularity (e.g., a number of times the article has been clicked on or viewed by users). Consequently, the search engine 114 is the first component used in the pipeline 112.

While the search engine 114 can find the more recent and/or more popular network resources 128 related to an investment theme 106, the search engine 114 is not configured to closely examine the content of the network resources 128 to confidently determine the relevance of a network resource 128 to the investment theme 106. Therefore, after the search engine 114 returns the network resources 128, the system applies a second component in the pipeline 112 to each network resource 128. The second component is the machine learning model 116 that has been generated and trained to implement natural language processing for investment themes 132. For example, the machine learning model 116 is generated and trained using deep-learning architectures such as deep neural networks, deep belief networks, deep reinforcement learning, recurrent neural networks, convolutional neural networks, and/or Transformers. In one example, the machine learning model 116 is generated and trained to implement natural language processing based on Sentence Bidirectional Encoder Representations from Transformers (SBERT).

The machine learning model 116 receives the content 130 of a network resource 128 returned by the search engine 114 as an input and semantically determines a relevance of the content 130 to the investment theme 106. Accordingly, the machine learning model 116 is generated and trained to semantically understand the investment theme 106 and output a score 134 for the network resource. The score 134 represents a degree to which the content 130 discussed in the network resource 128 is relevant to the investment theme 106. The machine learning model 116 can then rank the network resources 128 received from the search engine 114 based on the relevance scores 134. This ranking produces a ranked list of network resources 136.

Semantic understanding includes identifying related words and phrases discussing the investment theme 106. As an example, if the investment theme 106 includes “electrical vehicles”, the discussion of “EV batteries” and/or “EV charging stations” is related to the investment theme 106 and the machine learning model 116 is trained to semantically understand these relationships. Furthermore, semantic understanding includes determining whether the relevant discussion in a network resource 128 is bullish (e.g., the values of relate stocks and ETFs are predicted to increase) or bearish (e.g., the values of related stocks and ETFs are predicted to decrease). Generally, bullish discussions of the investment theme 106 contribute to higher relevance scores 134 and bearish discussions of the investment theme 106 contribute to lower relevance scores 134.

The ranked list of the network resources 136 is passed to a third component in the pipeline 112. The third component is the named-entity recognition algorithm 118 configured to recognize entity representations (e.g., company names, ticker symbols) for securities that can be traded (e.g., i.e., bought and sold). In one example, the named-entity recognition algorithm 118 identifies a relevance threshold number N (e.g., N=25, N=50, N=100, N=1000) of the top-ranked network resources 138 from the ranked list of network resources 136. The system 102 then applies the named-entity recognition algorithm 118 to each of the top-ranked network resources 138 to recognize and extract entities 140 associated with a tradeable security. The recognized and extracted entities 140 are used to compile the list of investments 104 which can be provided (e.g., communicated via network(s) 122) for display in association with the investment theme 106, as illustrated in FIG. 1.

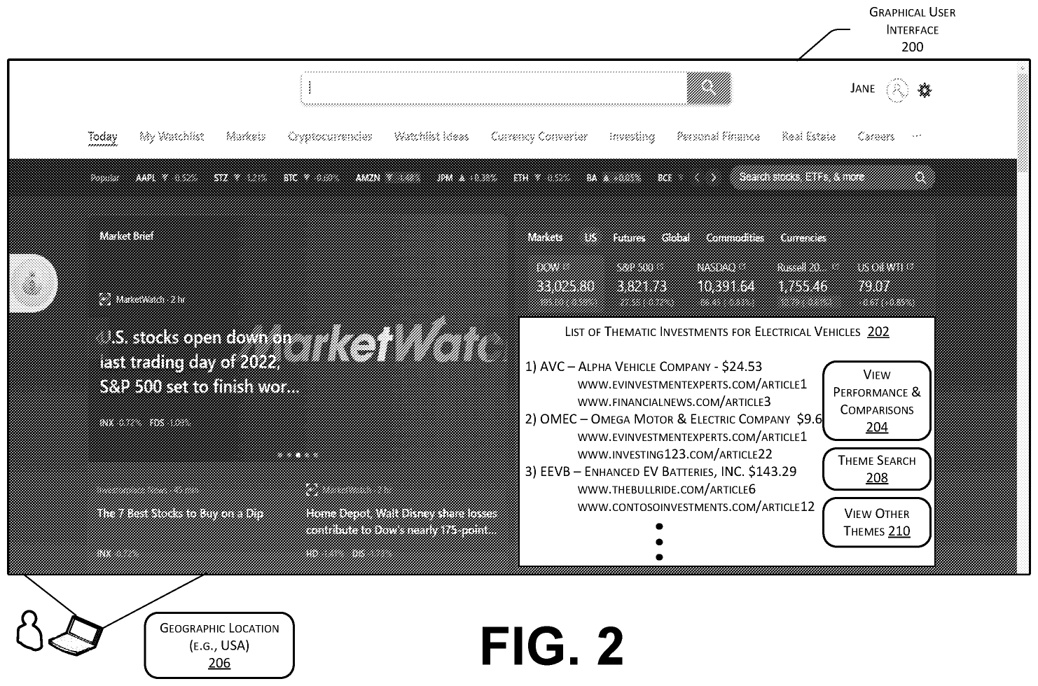

FIG. 2 illustrates an example graphical user interface 200 in which the list of investments 104 associated with an investment theme 106 can be displayed to a user via a computing device 108. As mentioned above, the graphical user interface 200 may be displayed via a browser window or an application (e.g., on a landing page associated with a website and/or a screen associated with an account). Additionally or alternatively, the list of investments 104 can be displayed via a new tab page of a browser (e.g., a page that curates and tailors content for a user), an operating system menu, a side or overlay pane, and so forth. Consequently, the “frame” described herein can surface to an end user at any one of various entry points with which the end user interacts on a computing device.

In the example of FIG. 2, the content of the graphical user interface 200 relates to a webpage for finances and investments. Moreover, the content is tailored to a user account (e.g., the user “Jane” is logged in to this website). Continuing the example above, the graphical user interface 200 includes a section, or a frame, for the list of thematic investments for electrical vehicles 202. As shown, the pipeline 112 of FIG. 1 has output example ticker symbols “AVC” (for the “Alpha Vehicle Company”), “OMEC” (for the “Omega Motor & Electric Company”), and “EEVB” (for “Enhanced EV Batteries, INC.”). While the list of investments shown in FIG. 2 includes three example ticker symbols, it is understood in the context of this disclosure that the list can include more investments or less investments.

Additionally, the frame can include linked URLs in which each of the ticker symbols, or other entity representations, are found. Accordingly, a user can efficiently access a network resource 128 in which an associated ticker symbol is discussed. The URLs that are presented to the user can be selected based on the relevance scores 134 (e.g., URLs for the higher-ranked network resources are the ones presented).

In various examples, the frame can include other metadata retrieved for, and displayed in association with, the ticker symbols. For instance, the metadata can include a current trading price of an investment (e.g., price per share) and/or a current increase or decrease percentage over the previous day's closing price. Additionally, the metadata can represent the historic performance of an investment (e.g., price performance over the last day, month, year, etc.) and/or the comparative performance of the investment against a relevant benchmark such as the S&P500. This type of metadata can be displayed in the initial frame or a different frame upon selection of a button 204, as illustrated.

In various examples, the pipeline 112 identifies and displays investments based on a geographic region 206 (e.g., United States of America, Japan, Europe, etc.) associated with the user, the computing device, and/or the query. Thus, if the geographic region 206 specifies the United States of America (e.g., the computing device is located in the USA, the query intentionally designates the USA, etc.), the list of investments is limited to investments that can be traded via trading platforms in the United States of America. In this way, the pipeline 112 is a tool that can scale to different geographic regions (e.g., different countries, different continents, different markets, etc.).

In further examples, the frame can include a button 208 for the user (e.g., “Jane”) to enter their own query defining an investment theme for the pipeline 112 to process. Additionally or alternatively, the frame can include a button 210 for the user to view investments for other investment themes (e.g., ones processed via system-generated queries 126).

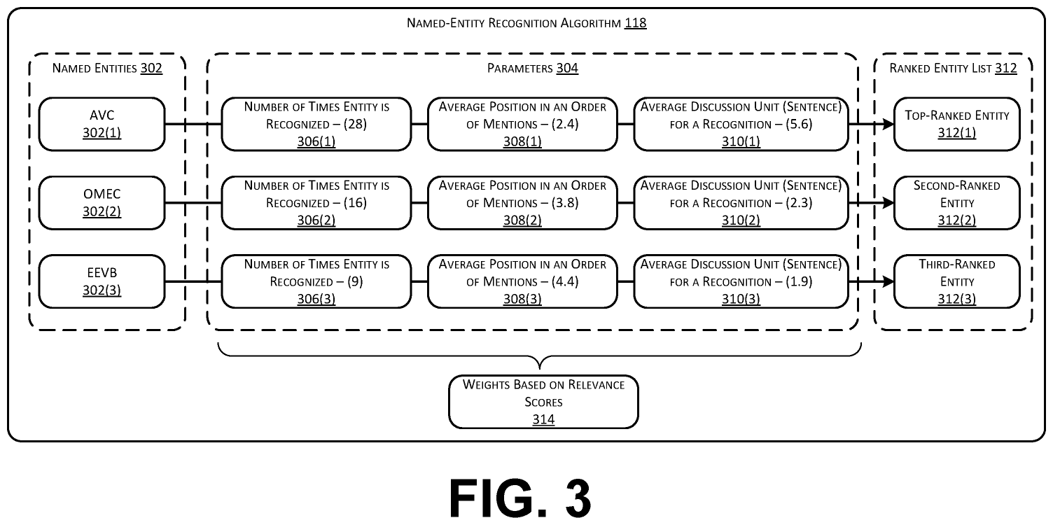

FIG. 3 illustrates an example diagram that captures how parameters associated with named entities (e.g., ticker symbols) can be used to produce a ranked list of investments. In addition to extracting representations of named entities 302, the named-entity recognition algorithm 118 can be configured to extract parameters 304 associated with the named entities 302. The parameters 304 can be used by the named-entity recognition algorithm 118 to produce a ranked list of entities so that the entities (e.g., ticker symbols) displayed in association with an investment theme can be presented in a ranked order.

As shown in FIG. 3, the named entities 302 include the example ticker symbols from FIG. 2—“AVC” 302(1), “OMEC” 302(2), and “EEVB” 302(3). A parameter 304 is a relevance indicator for an investment, and thus, can be used to indicate a degree to which an investment (e.g., “AVC” 302(1), “OMEC” 302(2), and “EEVB” 302(3)) is relevant to an investment theme 106 (e.g., “electrical vehicles). For example, a parameter 304 can include a number of times an entity is recognized and/or mentioned across the top-ranked network resources 138. As shown in FIG. 3, the entity “AVC” 302(1) is recognized and/or mentioned twenty-eight times 306(1), the entity “OMEC” 302(2) is recognized and/or mentioned sixteen times 306(2), and the entity “EEVB” 302(3) is recognized and/or mentioned nine times 306(3). The more a ticker symbol is mentioned in the top-ranked network resources 138 generally indicates that an investment is comparatively more relevant to the investment theme. Conversely, the less a ticker symbol is mentioned in the top-ranked network resources 138 generally indicates that an investment is comparatively less relevant to the investment theme.

In another example, a parameter 304 can include an average position in an order of recognitions and/or mentions for each of the top-ranked network resources 138. As shown in FIG. 3, the entity “AVC” 302(1) has an average position in an order of mentions of “2.4” 308(1), the entity “OMEC” 302(2) has an average position in an order of mentions of “3.8” 308(2), and the entity “EEVB” 302(3) has an average position in an order of mentions of “4.4” 308(3). When an article in the top-ranked network resources 138 mentions multiple ticker symbols in an order, the earlier in the order a ticker symbol is first mentioned generally indicates that an investment is comparatively more relevant to the investment theme. Conversely, the later in the order a ticker symbol is first mentioned generally indicates that an investment is comparatively less relevant to the investment theme.

In yet another example, a parameter 304 can include an average discussion unit (e.g., a word, a sentence, a paragraph, etc.) per entity mention across the top-ranked network resources 138. As shown in FIG. 3, the entity “AVC” 302(1) has an average of “5.6” sentences dedicated to discussing each mention of “AVC” 310(1), the entity “OMEC” 302(2) has an average of “2.3” sentences dedicated to discussing each mention of “OMEC” 310(2), and the entity “EEVB” 302(3) has an average of “1.9” sentences dedicated to discussing each mention of “EEVB” 310(3). The more average discussion units (e.g., sentences) dedicated to discussing a ticker symbol generally indicates that an investment is comparatively more relevant to the investment theme. Conversely, the less average discussion units (e.g., sentences) dedicated to discussing a ticker symbol generally indicates that an investment is comparatively less relevant to the investment theme.

Based on the example parameter(s) 304 discussed above, the named-entity recognition algorithm 118 produces a ranked entity list 312 where “AVC” 302(1) is the top-ranked entity 312(1), “OMEC” 302(2) is the second-ranked entity 312(2), and “EEVB” 302(3) is the third-ranked entity 312(3).

In various examples, the parameters 304 can be weighted based on the relevance scores 134 determined for each network resource of the top-ranked network resources 138. For example, a mention of a ticker symbol in the most relevant network resource can be weighted more than a mention of a ticker symbol in the least relevant network resource. In another example, a ticker symbol mentioned first in the most relevant network resource can be weighted more than a ticker symbol mentioned first in the least relevant network resource. In yet another example, three sentences used to discuss a ticker symbol in the most relevant network resource can be weighted more than three sentences used to discuss a ticker symbol in the least relevant network resource. Accordingly, FIG. 3 illustrates that the named-entity recognition algorithm 118 can apply weights 314, established based on the relevance scores 134, to the parameters 304.

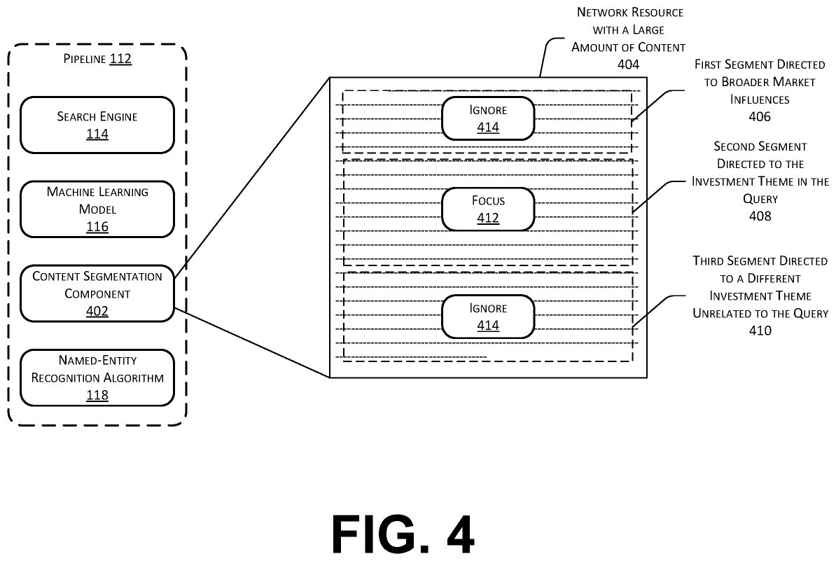

FIG. 4 illustrates an example diagram that captures how the content of a network resource can be segmented to focus the named-entity recognition and to protect against false positives. FIG. 4 illustrates the pipeline 112 of FIG. 1 with a content segmentation component 402 configured between the machine learning model 116 and the named-entity recognition algorithm 118. In various examples, the content segmentation component 402 uses the natural language processing output from the machine learning model 116 to generate segments for the article. The content segmentation component 402 is implemented to ensure that the named-entity recognition algorithm 118 focuses on a relevant segment of an article when recognizing and extracting entity representations.

To illustrate, FIG. 4 includes a network resource with a large amount of content 404. The content 404 includes a first segment that generally discusses broader market influences 406 and mentions investments that are not specifically associated with the investment theme identified in a query. The content 404 includes a second segment that discusses the investment theme in the query 408 and mentions investments related to the investment theme. This second segment 408 is the main contributor to the identification of the network resource as being a top-ranked network resource that is relevant to the investment theme. Finally, the content 404 includes a third segment that discusses a different investment theme unrelated to the query 410 and mentions investments related to the different investment theme.

The content segmentation component 402 is configured to analyze the content 404 to identify the segments 406, 408, and 410 and what the segments discuss. Accordingly, the content segmentation component 402 can designate a particular segment 408 for the named-entity recognition algorithm to focus 412 on. Stated alternatively, the content segmentation component 402 can designate particular segments 406, 410 for the named-entity recognition algorithm 118 to ignore 414. This ensures that only entity representations associated with the investment theme specified in the query are recognized and extracted and entity representations not associated with the investment theme specified in the query are ignored (e.g., ones mentioned in a discussion of broader market influences unrelated to the investment theme, ones mentioned in a discussion of a different investment theme, etc.). This reduces the false positives related to recognition and extraction.

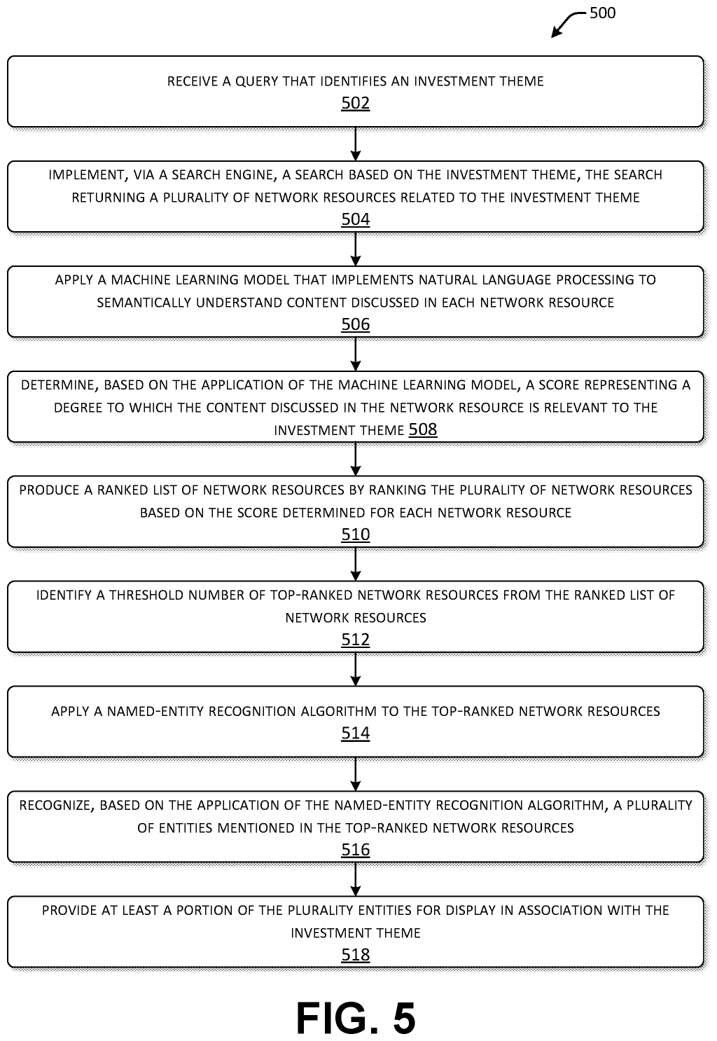

FIG. 5 represents an example process in accordance with various examples from the description of FIGS. 1-4. The example operations shown in FIG. 5 can be implemented on or otherwise embodied in one or more device(s) of the system 102.

The order in which the operations are described is not intended to be construed as a limitation, and any number of the described operations can be combined in any order and/or in parallel to implement each process. Moreover, the operations in FIG. 5 can be implemented in hardware, software, and/or a combination thereof. In the context of software, the operations represent computer-executable instructions that, when executed by one or more processing units, cause one or more processing units to perform the recited operations. For example, modules and other components described herein can be stored in a computer-readable storage media and executed by at least one processing unit to perform the described operations.

FIG. 5 is a flow diagram of an example method 500 for automatically providing a list of investments to users based on an investment theme.

At operation 502, a query that identifies an investment theme is received. At operation 504, a search based on the investment theme is implemented via a search engine. The search returns a plurality of network resources related to the investment theme.

At operation 506, a machine learning model that implements natural language processing is applied to each network resource returned via the search to semantically understand content discussed in the network resource. At operation 508, a score is determined based on the application of the machine learning model that implements natural language processing. The score represents a degree to which the content discussed in the network resource is relevant to the investment theme.

At operation 510, a ranked list of network resources is produced by ranking the plurality of network resources based on the score determined for each network resource. At operation 512, a threshold number of top-ranked network resources is identified from the ranked list of network resources.

At operation 514, a named-entity recognition algorithm is applied to the top-ranked network resources. At operation 516, a plurality of entities mentioned in the top-ranked network resources is recognized based on the application of the named-entity recognition algorithm. As described above, each entity of the plurality of entities is associated with a tradeable security.

At operation 518, at least a portion of the plurality entities are provided (e.g., communicated over a network) for display in association with the investment theme.

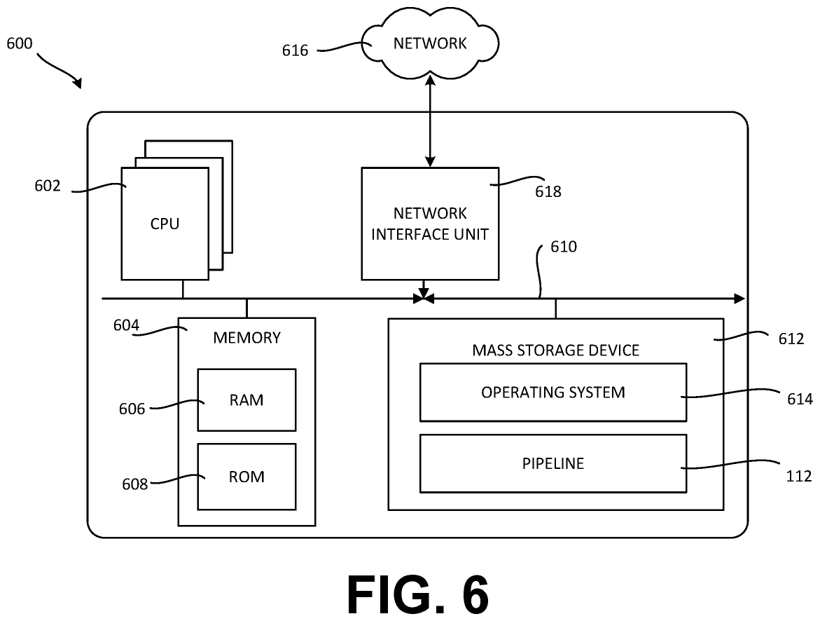

FIG. 6 is a computer architecture diagram showing an illustrative computer hardware and software architecture for a computing device that can implement the various technologies presented herein. In particular, the architecture illustrated in FIG. 6 can be utilized to implement a server or other type of computing device capable of implementing the system 102 in FIG. 1.

The computing device 600 illustrated in FIG. 6 includes a central processing unit 602 (“CPU”), a system memory 604, including a random-access memory 606 (“RAM”) and a read-only memory (“ROM”) 608, and a system bus 610 that couples the memory 604 to the CPU 602. A basic input/output system (“BIOS” or “firmware”) containing the basic routines that help to transfer information between elements within the computing device 600, such as during startup, can be stored in the ROM 608. The computing device 600 further includes a mass storage device 612 for storing an operating system 614, application programs, and/or other types of programs. The mass storage device 612 can also be configured to store other types of data and components, such as those found in the pipeline 112.

The mass storage device 612 is connected to the CPU 602 through a mass storage controller connected to the bus 610. The mass storage device 612 and its associated computer readable media provide non-volatile storage for the computing device 600. Although the description of computer readable media contained herein refers to a mass storage device, such as a hard disk, CD-ROM drive, DVD-ROM drive, or USB storage key, it should be appreciated by those skilled in the art that computer readable media can be any available computer storage media or communication media that can be accessed by the computing device 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

By way of example, and not limitation, computer storage media can include volatile and non-volatile, removable and non-removable media implemented in any method or technology for storage of information such as computer readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computing device 600. For purposes of the claims, the phrase “computer storage medium,” and variations thereof, does not include waves or signals per se or communication media.

According to various configurations, the computing device 600 can operate in a networked environment using logical connections to remote computers through a network such as the network 616. The computing device 600 can connect to the network 616 through a network interface unit 618 connected to the bus 610. It should be appreciated that the network interface unit 618 can also be utilized to connect to other types of networks and remote computer systems.

It should be appreciated that the software components described herein, when loaded into the CPU 602 and executed, can transform the CPU 602 and the overall computing device 600 from a general-purpose computing device into a special-purpose computing device customized to facilitate the functionality presented herein. The CPU 602 can be constructed from any number of transistors or other discrete circuit elements, which can individually or collectively assume any number of states. More specifically, the CPU 602 can operate as a finite-state machine, in response to executable instructions contained within the software modules disclosed herein. These computer-executable instructions can transform the CPU 602 by specifying how the CPU 602 transitions between states, thereby transforming the transistors or other discrete hardware elements constituting the CPU 602.

The disclosure presented herein also encompasses the subject matter set forth in the following clauses.

Example Clause A, a method comprising: receiving a query that identifies an investment theme; implementing, via a search engine, a search based on the investment theme, the search returning a plurality of network resources related to the investment theme; for a network resource of the plurality of network resources: applying, by a processing unit, a machine learning model that implements natural language processing to semantically understand content discussed in the network resource; determining, based on the application of the machine learning model that implements natural language processing, a score representing a degree to which the content discussed in the network resource is relevant to the investment theme; producing a ranked list of network resources by ranking the plurality of network resources based on the score determined for each network resource of the plurality of network resources; identifying a threshold number of top-ranked network resources from the ranked list of network resources; applying a named-entity recognition algorithm to the top-ranked network resources; recognizing, based on the application of the named-entity recognition algorithm, a plurality of entities mentioned in the top-ranked network resources, wherein each entity of the plurality of entities is associated with a tradeable security; and providing at least a portion of the plurality entities for display in association with the investment theme.

Example Clause B, the method of Example Clause A, wherein the machine learning model that implements natural language processing is trained to semantically understand the investment theme.

Example Clause C, the method of Example Clause A or Example Clause B, wherein the named-entity recognition algorithm is configured to identify ticker symbols that represent the plurality of entities.

Example Clause D, the method of Example Clause C, wherein providing at least the portion of the plurality entities for display in association with the investment theme comprises providing a portion of the ticker symbols that correspond to the portion of the plurality entities.

Example Clause E, the method of Example Clause D, further comprising: retrieving metadata associated with the portion of ticker symbols, the metadata including at least one of a current price or a historic performance; and displaying the portion of the ticker symbols and the metadata in a frame via at least one of a new tab page of a browser, an operating system menu, or a side pane.

Example Clause F, the method of any one of Example Clauses A through E, wherein a number of the plurality of network resources returned based on the search is limited to a threshold number.

Example Clause G, the method of any one of Example Clauses A through F, further comprising: extracting, based on the application of the named-entity recognition algorithm, at least one parameter associated with each entity of the plurality of entities; and producing a ranked list of entities by ranking the plurality of entities based on the at least one parameter associated with each entity of the plurality of entities, wherein the portion of the plurality entities provided for display in association with the investment theme comprises a threshold number of top-ranked entities from the ranked list of entities.

Example Clause H, the method of Example Clause G, wherein the at least one parameter comprises a number of times a corresponding entity is mentioned in the top-ranked network resources.

Example Clause I, the method of Example Clause G or Example Clause H, wherein the at least one parameter comprises an average position of a corresponding entity in an order of mentioned entities.

Example Clause J, the method of any one of Example Clauses G through I, wherein the at least one parameter comprises an average number of units dedicated to a discussing a corresponding entity.

Example Clause K, the method of any one of Example Clauses G through J, wherein the at least one parameter is a weighted parameter based on the score determined for each network resource of the top-ranked network resources.

Example Clause L, the method of any one of Example Clauses A through K, further comprising, for a top-ranked network resource, performing content segmentation to identify a first content segment on which to focus the named-entity recognition algorithm and a second content segment which the named-entity recognition algorithm ignores.

Example Clause M, the method of any one of Example Clauses A through L, wherein the plurality of network resources and the plurality of entities are related to a particular geographic region associated with the query.

Example Clause N, a system comprising: a processing unit; and a computer-readable storage medium having computer-executable instructions stored thereupon, which, when executed by the processing unit, cause the processing unit to perform operations comprising: implementing, via a search engine, a search based on an investment theme, the search returning a plurality of network resources related to the investment theme; for a network resource of the plurality of network resources: applying a machine learning model that implements natural language processing to semantically understand content discussed in the network resource; determining, based on the application of the machine learning model that implements natural language processing, a score representing a degree to which the content discussed in the network resource is relevant to the investment theme; producing a ranked list of network resources by ranking the plurality of network resources based on the score determined for each network resource of the plurality of network resources; identifying a threshold number of top-ranked network resources from the ranked list of network resources; applying a named-entity recognition algorithm to the top-ranked network resources; and recognizing, based on the application of the named-entity recognition algorithm, a plurality of entities mentioned in the top-ranked network resources, wherein each entity of the plurality of entities is associated with a tradeable security.

Example Clause O, the system of Example Clause N, wherein the machine learning model that implements natural language processing is trained to semantically understand the investment theme.

Example Clause P, the system of Example Clause N or Example Clause O, wherein the named-entity recognition algorithm is configured to identify ticker symbols that represent the plurality of entities.

Example Clause Q, the system of any one of Example Clauses N through P, wherein the operations further comprise: extracting, based on the application of the named-entity recognition algorithm, at least one parameter associated with each entity of the plurality of entities; and producing a ranked list of entities by ranking the plurality of entities based on the at least one parameter associated with each entity of the plurality of entities, wherein the portion of the plurality entities provided for display in association with the investment theme comprises a threshold number of top-ranked entities from the ranked list of entities.

Example Clause R, the system of Example Clause Q, wherein the at least one parameter comprises at least one of: a number of times a corresponding entity is mentioned in the top-ranked network resources; an average position of a corresponding entity in an order of mentioned entities; or an average number of units dedicated to a discussing a corresponding entity.

Example Clause S, the system of Example Clause Q or Example Clause R, wherein the at least one parameter is a weighted parameter based on the score determined for each network resource of the top-ranked network resources.

Example Clause T, a computer-readable storage medium having computer-executable instructions stored thereupon, which, when executed by a processing unit, cause the processing unit to perform operations comprising: implementing, via a search engine, a search based on an investment theme, the search returning a plurality of network resources related to the investment theme; for a network resource of the plurality of network resources: applying a machine learning model that implements natural language processing to semantically understand content discussed in the network resource; determining, based on the application of the machine learning model that implements natural language processing, a score representing a degree to which the content discussed in the network resource is relevant to the investment theme; producing a ranked list of network resources by ranking the plurality of network resources based on the score determined for each network resource of the plurality of network resources; identifying a threshold number of top-ranked network resources from the ranked list of network resources; applying a named-entity recognition algorithm to the top-ranked network resources; and recognizing, based on the application of the named-entity recognition algorithm, a plurality of entities mentioned in the top-ranked network resources, wherein each entity of the plurality of entities is associated with a tradeable security.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element (e.g., two different investments, etc.).

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter. All examples are provided for illustrative purposes and is not to be construed as limiting.

What is claimed is:

1. A method comprising:
receiving a query that identifies an investment theme;
implementing, via a search engine, a search based on the investment theme, the search returning a plurality of network resources related to the investment theme;
for a network resource of the plurality of network resources:
applying, by a processing unit, a machine learning model that implements natural language processing to semantically understand content discussed in the network resource;
determining, based on the application of the machine learning model that implements natural language processing, a score representing a degree to which the content discussed in the network resource is relevant to the investment theme;
producing a ranked list of network resources by ranking the plurality of network resources based on the score determined for each network resource of the plurality of network resources;
identifying a threshold number of top-ranked network resources from the ranked list of network resources;
applying a named-entity recognition algorithm to the top-ranked network resources;
recognizing, based on the application of the named-entity recognition algorithm, a plurality of entities mentioned in the top-ranked network resources, wherein each entity of the plurality of entities is associated with a tradeable security; and
providing at least a portion of the plurality entities for display in association with the investment theme.

2. The method of claim 1, wherein the machine learning model that implements natural language processing is trained to semantically understand the investment theme.

3. The method of claim 1, wherein the named-entity recognition algorithm is configured to identify ticker symbols that represent the plurality of entities.

4. The method of claim 3, wherein providing at least the portion of the plurality entities for display in association with the investment theme comprises providing a portion of the ticker symbols that correspond to the portion of the plurality entities.

5. The method of claim 4, further comprising:
retrieving metadata associated with the portion of ticker symbols, the metadata including at least one of a current price or a historic performance; and
displaying the portion of the ticker symbols and the metadata in a frame via at least one of a new tab page of a browser, an operating system menu, or a side pane.

6. The method of claim 1, wherein a number of the plurality of network resources returned based on the search is limited to a threshold number.

7. The method of claim 1, further comprising:
extracting, based on the application of the named-entity recognition algorithm, at least one parameter associated with each entity of the plurality of entities; and
producing a ranked list of entities by ranking the plurality of entities based on the at least one parameter associated with each entity of the plurality of entities, wherein the portion of the plurality entities provided for display in association with the investment theme comprises a threshold number of top-ranked entities from the ranked list of entities.

8. The method of claim 7, wherein the at least one parameter comprises a number of times a corresponding entity is mentioned in the top-ranked network resources.

9. The method of claim 7, wherein the at least one parameter comprises an average position of a corresponding entity in an order of mentioned entities.

10. The method of claim 7, wherein the at least one parameter comprises an average number of units dedicated to a discussing a corresponding entity.

11. The method of claim 7, wherein the at least one parameter is a weighted parameter based on the score determined for each network resource of the top-ranked network resources.

12. The method of claim 1, further comprising, for a top-ranked network resource, performing content segmentation to identify a first content segment on which to focus the named-entity recognition algorithm and a second content segment which the named-entity recognition algorithm ignores.

13. The method of claim 1, wherein the plurality of network resources and the plurality of entities are related to a particular geographic region associated with the query.

14. A system comprising:
a processing unit; and
a computer-readable storage medium having computer-executable instructions stored thereupon, which, when executed by the processing unit, cause the processing unit to perform operations comprising:
implementing, via a search engine, a search based on an investment theme, the search returning a plurality of network resources related to the investment theme;
for a network resource of the plurality of network resources:
applying a machine learning model that implements natural language processing to semantically understand content discussed in the network resource;
determining, based on the application of the machine learning model that implements natural language processing, a score representing a degree to which the content discussed in the network resource is relevant to the investment theme;
producing a ranked list of network resources by ranking the plurality of network resources based on the score determined for each network resource of the plurality of network resources;
identifying a threshold number of top-ranked network resources from the ranked list of network resources;
applying a named-entity recognition algorithm to the top-ranked network resources; and
recognizing, based on the application of the named-entity recognition algorithm, a plurality of entities mentioned in the top-ranked network resources, wherein each entity of the plurality of entities is associated with a tradeable security.

15. The system of claim 14, wherein the machine learning model that implements natural language processing is trained to semantically understand the investment theme.

16. The system of claim 14, wherein the named-entity recognition algorithm is configured to identify ticker symbols that represent the plurality of entities.

17. The system of claim 14, wherein the operations further comprise:
extracting, based on the application of the named-entity recognition algorithm, at least one parameter associated with each entity of the plurality of entities; and
producing a ranked list of entities by ranking the plurality of entities based on the at least one parameter associated with each entity of the plurality of entities, wherein the portion of the plurality entities provided for display in association with the investment theme comprises a threshold number of top-ranked entities from the ranked list of entities.

18. The system of claim 17, wherein the at least one parameter comprises at least one of:
a number of times a corresponding entity is mentioned in the top-ranked network resources;
an average position of a corresponding entity in an order of mentioned entities; or
an average number of units dedicated to a discussing a corresponding entity.

19. The system of claim 17, wherein the at least one parameter is a weighted parameter based on the score determined for each network resource of the top-ranked network resources.

20. A computer-readable storage medium having computer-executable instructions stored thereupon, which, when executed by a processing unit, cause the processing unit to perform operations comprising:
implementing, via a search engine, a search based on an investment theme, the search returning a plurality of network resources related to the investment theme;
for a network resource of the plurality of network resources:
applying a machine learning model that implements natural language processing to semantically understand content discussed in the network resource;
determining, based on the application of the machine learning model that implements natural language processing, a score representing a degree to which the content discussed in the network resource is relevant to the investment theme;
producing a ranked list of network resources by ranking the plurality of network resources based on the score determined for each network resource of the plurality of network resources;
identifying a threshold number of top-ranked network resources from the ranked list of network resources;
applying a named-entity recognition algorithm to the top-ranked network resources; and
recognizing, based on the application of the named-entity recognition algorithm, a plurality of entities mentioned in the top-ranked network resources, wherein each entity of the plurality of entities is associated with a tradeable security.
